(19) United States
(12) Patent Application Publication
(10) Pub. No.: US 2021/0388603 A1
(43) Pub. Date: Dec. 16, 2021

(54) CONSTRUCTION OF A TINY HOUSE ON WHEELS

(71) Applicant: Fred's Tiny Houses Pty Ltd, Victoria (AU)

(72) Inventor: Fred SCHULTZ, Victoria (AU)

(73) Assignee: Fred's Tiny Houses Pty Ltd, Victoria (AU)

(21) Appl. No.: 17/285,950

(22) PCT Filed: Oct. 16, 2019
(86) PCT No.: PCT/AU2019/051128

§ 371 Date: Apr. 16, 2021

(30) Foreign Application Priority Data
Oct. 17, 2018 (AU) 2018903937

(51) Int. Cl. E04B 1/343; E04B 2/56; E04B 5/02; E04B 7/02; E04H 1/12; B60P 3/32

(52) U.S. Cl. CPC E04B 1/34352; E04B 2/56; E04B 5/02; E04B 2103/04; E04H 1/1205; B60P 3/32; E04B 7/024

(57) ABSTRACT

A mobile building constructed on a trailer, comprising:
a wheeled trailer upon which the building is built,
a floor and a plurality of walls secured to the trailer; and
a roof structure,
wherein external sides of the walls are braced with sheeting secured to the walls, the sheeting extending from a base of the building and securing to the roof structure.

### FIELD OF THE INVENTION

The present invention relates to the construction of mobile buildings, in particular the construction of small homes built upon trailers, more commonly known as a tiny house on wheels.

### BACKGROUND

In recent years the popularity of a tiny house on wheels has increased, for many reasons such as cost, simplicity, sustainability and lifestyle. Buildings of this type are constructed more like a house than a traditional caravan or RV as they are intended to a viable alternative for long term occupation.

Buildings of this type need to not only comply with standards of fixed buildings, but also be able to withstand the wind loadings, acceleration forces and in particular the vibrations subject to it during road transportation. With more and more people choosing to live in this type of building, the need to improve construction methods that exceeds the building code has become evident.

There is a need to address the above, and/or at least provide a useful alternative.

### SUMMARY

According to one aspect of the invention there is provided a mobile building constructed on a trailer, comprising:

a wheeled trailer upon which the building is built,

a floor and a plurality of walls secured to the trailer; and

a roof structure,

wherein external sides of the walls are braced with sheeting secured to the walls, the sheeting extending from a base of the building and securing to the roof structure.

According to preferred embodiments of the invention, the sheeting extends from a floor joist to the roof structure. This is distinct from traditional building methods of bracing with plywood where only a few corners of the building are braced and only the top and bottom plate are secured together. Such practices arise through construction methods used in areas of high wind or cyclonic loading and have little regard for the issue of road transport induced vibrations.

Preferably, the roof structure has a lowermost purlin that presents a flat face generally parallel with the external sides of the walls, the sheeting being secured to the lowermost roof purlin on the flat face.

Preferably, the sheeting is formed of plywood. Preferably, the sheeting is secured to the walls using an adhesive and staples. The adhesive may be a combination elastic joint sealant and adhesive.

Preferably, the trailer has a plurality of upwardly extending tabs extending therefrom, the tabs configured for securing floor joists thereto. The trailer may also have a plurality of elongate ties extending upwardly therefrom, the ties being configured for securing the walls to the trailer.

According to another aspect of the invention, there is provided a mobile building constructed on a trailer, comprising:

a wheeled trailer upon which the building is built;

a floor and a plurality of walls secured to the trailer; and

a roof structure,

wherein the trailer has a plurality of upwardly extending tabs extending therefrom, the tabs configured for securing floor joists thereto.

Preferably, the tabs are welded to the trailer

According to another aspect of the invention, there is provided a mobile building constructed on a trailer, comprising:

a wheeled trailer upon which the building is built;

a floor and a plurality of walls secured to the trailer; and

a roof structure,

wherein the trailer has a plurality of elongate tie members extending upwardly therefrom, the ties being configured for securing the walls to the trailer.

Preferably, the ties are in the form of elongate, generally planar strips secured to the trailer.

According to another aspect of the invention, there is provided a method of constructing a mobile building, including the steps of:

providing a wheeled trailer upon which the building is to be built;

securing a floor, a plurality of walls and a roof structure to the trailer; and

bracing external sides of the walls with sheeting secured to the walls and extending from a base of the building to the roof structure.

According to preferred embodiments, the method further includes the steps of mitre cutting a lowermost purlin of the roof structure to present a flat face generally parallel with the external sides of the walls, and securing the sheeting to the lowermost roof purlin on the flat face.

The method can further include the step of securing floor joists to a plurality of upwardly extending tabs extending from the trailer. Preferably, the method further includes the step of securing the walls to a plurality of elongate ties extending upwardly from the trailer.

### BRIEF DESCRIPTION OF THE DRAWINGS

In order that the invention may be more easily understood, an embodiment will now be described, by way of example only, with reference to the accompanying drawings, in which:

FIG. 1: is a cutaway perspective view of a mobile building according to a preferred embodiment of the invention, the building being constructed on a wheeled trailer;

FIG. 2: is a sectional end view of the building removed from the trailer;

FIG. 3: is a close sectional end view of an interface between a roof and wall of the building;

FIG. 4: is another close sectional end view of an interface between a roof and wall of the building;

FIG. 5: is a close sectional end view of an interface between a floor and wall of the building;

FIG. 6: is another close sectional end view of an interface between a floor and wall of the building;

FIG. 7: is a perspective view of a trailer for use with the building; and

FIG. 8: is a perspective view of another trailer for use with the building.

### DETAILED DESCRIPTION

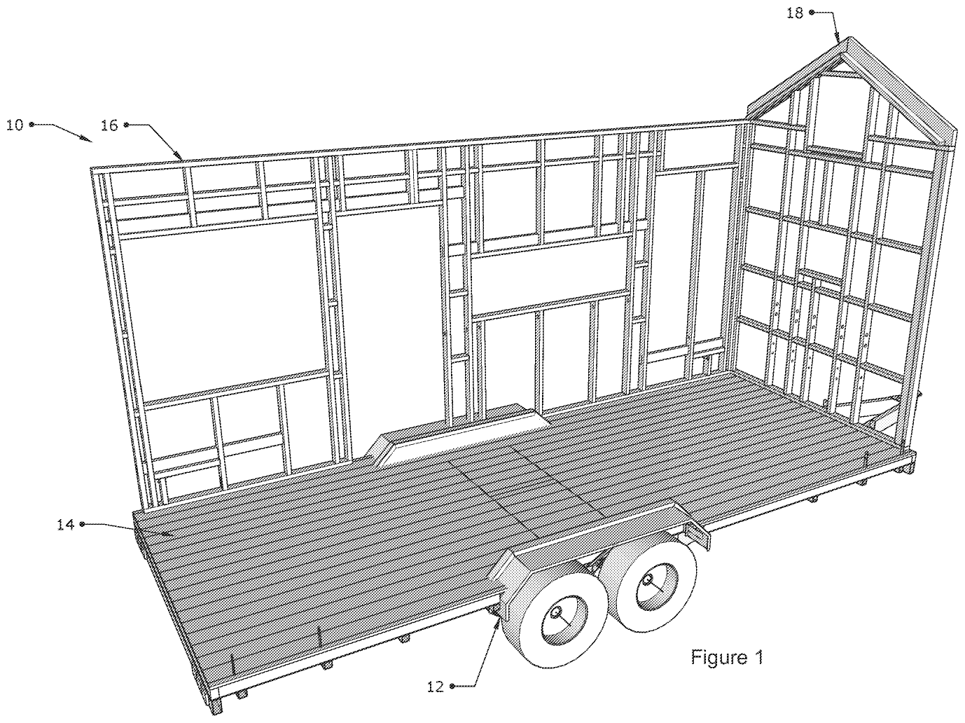

A mobile building 10 according to a preferred embodiment of the invention is shown in FIG. 1. The mobile building is a tiny house on wheels and configured to be constructed on a wheeled trailer 12 which is towable by a road vehicle.

The building 10 includes a wheeled trailer 12 and a building of a generally conventional type mounted thereon and secured thereto, the building having a structure including a floor structure 14 and a plurality of walls 16 secured to the trailer 12, and a roof structure 18.

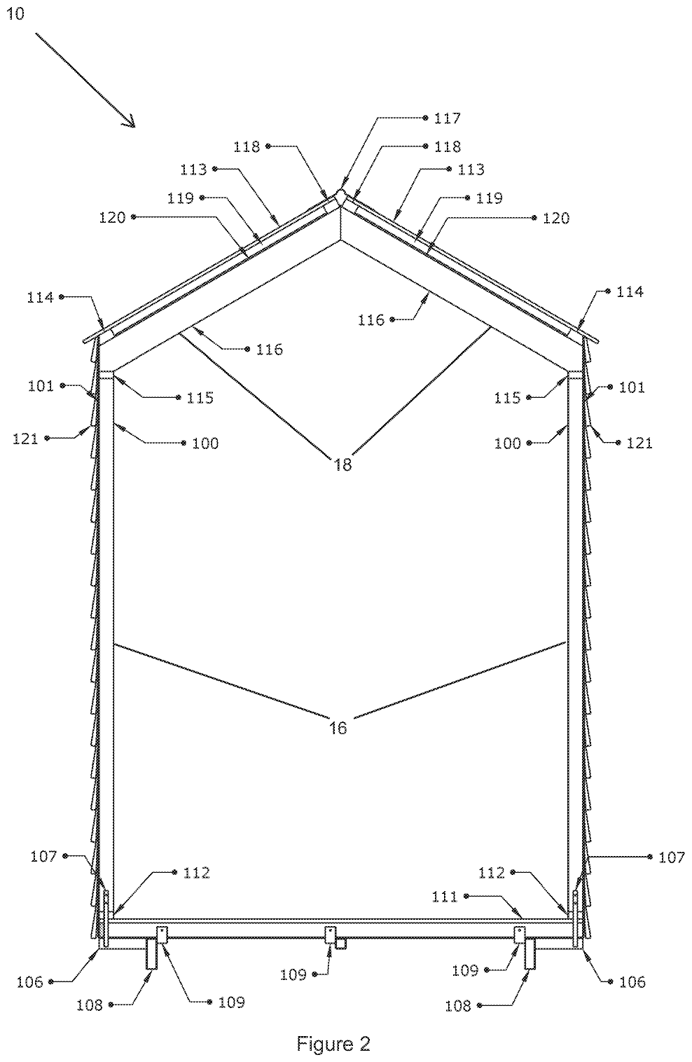

As illustrated in FIGS. 2 to 6, to provide additional strength to the building 10, particularly under vibrations imparted during transportation and so that it can safely be transported, external sides of the walls 16 are braced with sheeting 101 secured to the walls 16. The sheeting 20 extends from a base of the building 10 below a bottom plate and secures to the roof structure 18 above the top plate, thereby tying the roof structure 18, the walls 16 and floor structure 14 to the trailer 12 and providing a building 10 of improved strength and rigidity that enjoys the benefits of a conventionally constructed building though is portable.

In particular, building 10 enjoys the performance of a conventional building with regard to the shedding of water, something that previous mobile homes have had difficulty with. For example, conventional caravans are not designed to last a long time and their ability to shed water relies largely on silicon caulking, which fails over time, leading to water intrusion, mould and unpleasant odours eventually. Such problems are generally not present in buildings built according to the present disclosure. Furthermore, building 10 has a usable life expectancy closer to that of a traditional building and also provides a level of insulation not previously possible with other mobile homes. This arises as caravans are required to be more portable and generally of a lightweight construction whereas a tiny house on wheels sacrifices light weight for structural integrity and longevity.

In the illustrated embodiments, the sheeting 101 extends from a floor joist 110 to the roof structure 18. Such a configuration also avoids the need for conventional threaded rod to secure the top plate to the bottom plate. As will be discussed further below, the sheeting can be installed on all side walls of the house, including the long sides (front and back) and short sides (ends).

The roof structure 18 includes a rafter 116, roofing material 113, a ridge cap 117, purlins 114, 118 and a radiant barrier 120. Unlike conventional construction, radiant barrier 120 is secured to an upper side of the rafter 116 and secured in place without sagging (traditionally it is allowed to sag) to provide additional roof space, improve visual appearance, and improve insulation by creating air gap 119.

In the illustrated embodiments a gable roof is shown, though those skilled in the art will appreciate that the roof may take other forms, such as a generally flat or inclined roof. Any roof style may be used, provided that a mitre cut purlin can be used.

The roof structure 18 has an upper purlin 118 and a lower purlin 114, although it will be appreciated that additional purlins may be provided. The lowermost purlin 114 is formed, preferably via a mitre cut, to present a flat face generally parallel with the external sides of the walls 16. The sheeting 101 is secured to the lowermost roof purlin 114 on the flat face. Siding 121 is secured over the bracing to provide an external wall material.

On the long sides of the building 10, the sheeting 101 meets the purlin 114 and can be readily secured thereto. On the short sides (ends) of the building the sheeting will again extend from the floor joist 110 to the roof purlins, though it will take a generally triangular shape at an upper section. To fill the space between the lowermost purlin 114 and the uppermost purlin 118, timber blocking is installed and secured. This allows an uppermost edge of the sheeting between the purlins 114, 118 to be secured to the blocking using staples and adhesive, thereby avoiding a free edge.

In the illustrated embodiments, the sheeting 101 is formed of plywood, preferably 4.5 mm thick plywood. Previously 7 mm plywood has been used on conventional buildings, though the weight of such a thick material is undesirable for use on a mobile building. By securing the sheeting 101 to locations above the top plate and below the bottom plate and using an adhesive, improved structural strength, especially to counter vibrations that make traditional building construction methods prone to failure, can be obtained with a weight saving from using lower gauge material. The sheeting 101 is secured to the walls 16 using an adhesive 102, which is preferably is a combination elastic joint sealant and adhesive and which is applied as a continuous bead. The use of the sealant and adhesive is important to secure all edges of the plywood so that it doesn't flap. To prevent flapping, the sealant and adhesive secures the plywood to the different elements of the wall 16, particularly the connecting vertical studs and noggins. Plywood sheets are typically unable to extend from the floor joists to the roof structure as a single sheet, so joins are required and it is in the region of these joins that the adhesive is particularly useful in securing the edges of the sheeting 101. Also, the spacing of staples 104 is chosen to prevent flapping and dislodging of the sheeting 101. In this regard, a 50 mm spacing is preferably used. In preferred embodiments, the adhesive is Sikaflex 11FC. Such an adhesive has a resilience which is very beneficial with buildings of this type which are subject to vibrations during road transportation. Other previously used adhesives are known for becoming brittle over time and failing and are thus unsuitable.

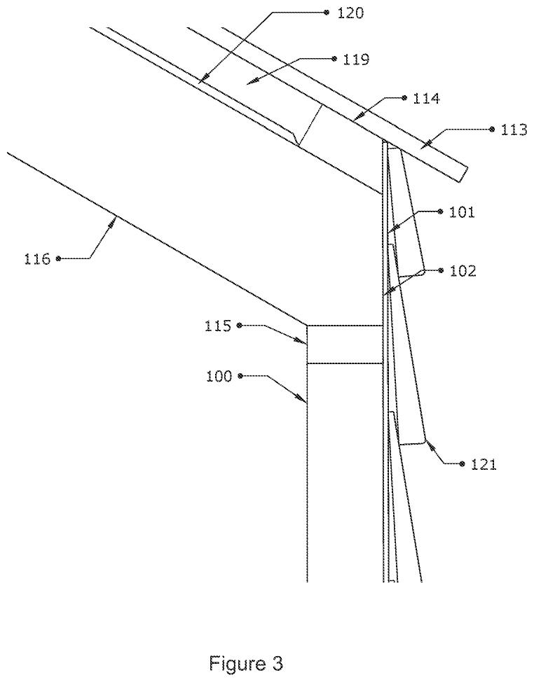

As illustrated in FIG. 3, staples 104 may also be used to secure the sheeting 101 to the building. Staples 104 are preferable to nails applied with a nail gun, which can deform the sheeting 101 and damage it as often the force used is too great. With too much force a nail can blow through plywood and it is recommended that during manufacture the force of the stapler be set low and any finishing that is required, which can be determined by visual inspection of by touch, be done by hand.

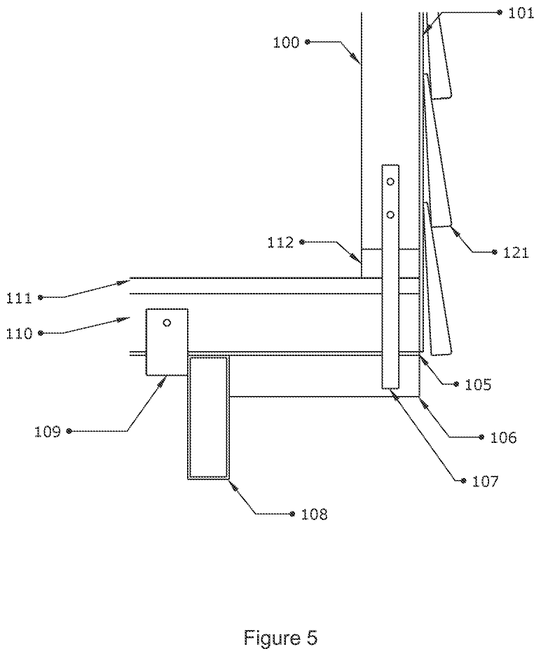

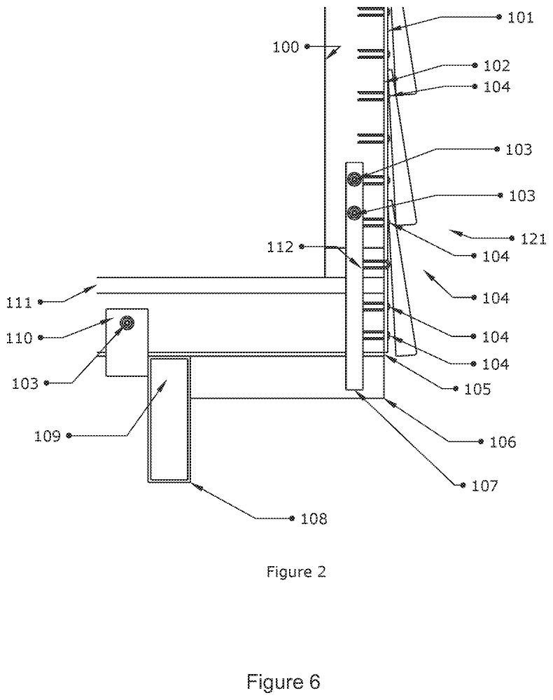

With reference to FIGS. 5 and 6, the floor structure 14 includes flooring material 111, a floor joist 110 and plywood underlayment 105. Plywood underlayment 105 allows insulation to be inserted as it creates a cavity thereabove. To secure the floor structure 14 to the trailer 12, a plurality of floor joist tie downs 109 are provided. The floor joist tie downs are preferably upstanding and welded to the trailer 12. By providing floor joist tie downs 109 which are upstanding, the floor joists 110 are mounted on the chassis rail 108 so that the flooring material 111 can be spaced from and not touching the chassis rail 108 or any of the steel of the trail, which provides improved insulation by breaking the thermal circuit between the chassis rail 108 which will take the external temperature and transfer it to the flooring material 111, resulting in a cold floor within the building. There is also provided a cavity for installing insulation under floor. Such an arrangement is superior to previous configurations that use steel floor joists.

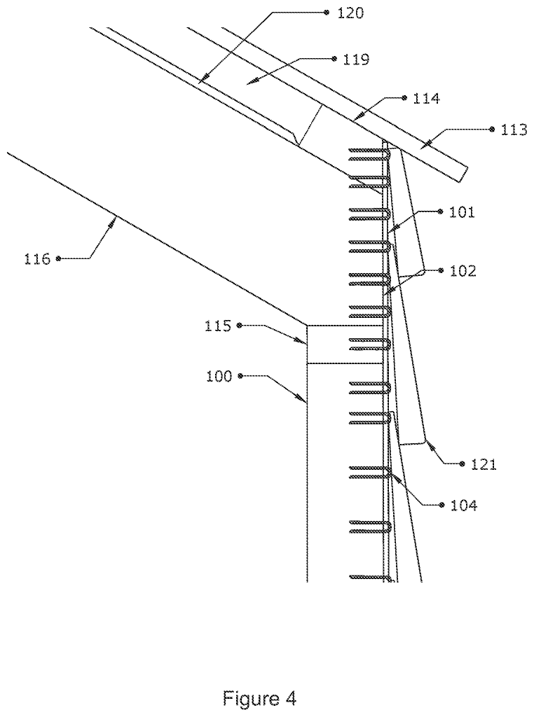

The walls 16 include a stud wall 100, bottom plate 112 and top plate 115 (see FIGS. 3 and 4). The walls 16 are secured to the trailer 12 with a plurality of stud wall tie downs 107. The tie downs 107 are upstanding and preferably welded to the trailer 12 via a cantilevered support 106 secured to chassis rail 108. Tie downs 107 result in effective securement of the walls 16 to the trailer 12 without requiring the use of additional fasteners or threaded rods, which are undesirable. In this regard, to accommodate expansion and contraction of the frame, the rods can only be tightened a certain amount, which results in the rods being loose a large portion of the time and thus ineffective and prone to rattling in their hole. In contrast, plywood bracing can expand and contract with frame at a similar rate so as to be constantly effective.

The stud walls 100 are bolted to the tie downs 107 to secure the walls 16 to the trailer 12. M8 high tensile bolts with Nyloc nuts may be used in this regard, those skilled in the art will appreciate that other commercially available fasteners may be adequate for use in this regard. Nyloc nuts or similar fasteners are also used to secure the floor joists 110.

Again, staples 104 may be provided to secure the sheeting 101 to the wall 16, as illustrated in FIG. 6.

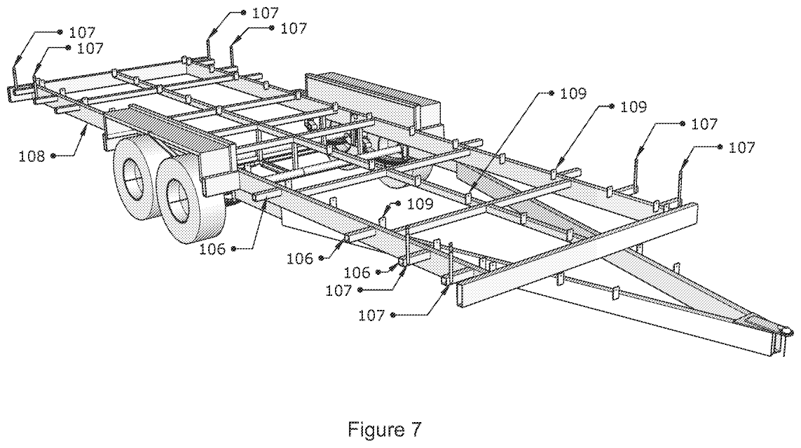

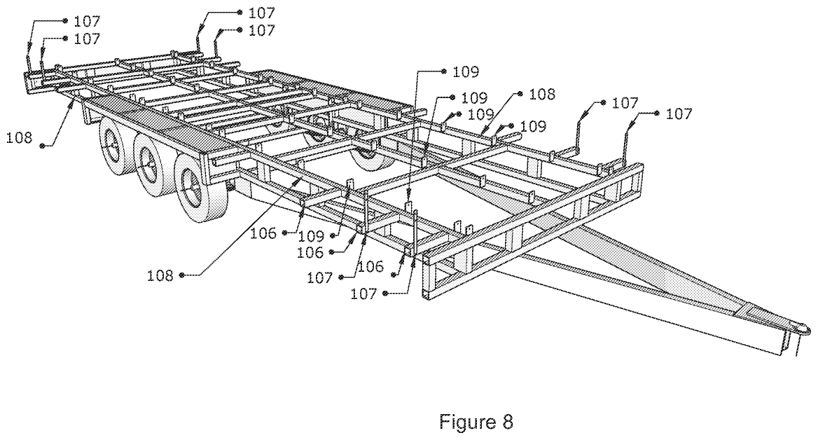

FIGS. 7 and 8 illustrate suitable trailers for use with the invention. FIG. 7 illustrates a trailer 12a having protruding wheel guards. With such a trailer, the footprint of the building 10 is narrowed in a central region to accommodate the wheel guards. Trailer 12a has a plurality of wall tie downs 107 and a plurality of floor joist tie downs 109. The wall tie downs 107 are secured to the cantilevered supports 106, which are secured to chassis rails 108.

The trailer 12b of FIG. 8 is a flatbed trailer. Again, trailer 12b has a plurality of wall tie downs 107 and a plurality of floor joist tie downs 109. The wall tie downs 107 are secured to the cantilevered supports 106, which are secured to chassis rails 108.

Both of trailers 12a, 12b are of a ladder frame construction and preferably welded. The ladder frame is mounted on the chassis rails to separate the chassis rails from each other, such a construction provides for mounting of batteries under the floor and between frame members. Advantageously, the weight of such devices is kept low in the building 10, reducing negative impacts on handling dynamics during transportation.

Many modifications of the above embodiments will be apparent to those skilled in the art without departing from the scope of the present invention.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A mobile building constructed on a trailer, comprising:
a wheeled trailer upon which the building is built,
a floor and a plurality of walls secured to the trailer; and
a roof structure,
wherein external sides of the walls are braced with sheeting secured to the walls, the sheeting extending from a base of the building and securing to the roof structure.

2. A building according to claim 1, wherein the sheeting extends from a floor joist to the roof structure.

3. A building according to claim 1, wherein the roof structure has a lowermost purlin that presents a flat face generally parallel with the external sides of the walls, the sheeting being secured to the lowermost roof purlin on the flat face.

4. A building according to claim 1, wherein the sheeting is formed of plywood.

5. A building according to claim 1, wherein the bracing is secured to the walls using an adhesive and staples.

6. A building according to claim 1, wherein the adhesive is a combination elastic joint sealant and adhesive.

7. A building according to claim 1, wherein the trailer has a plurality of upwardly extending tabs extending therefrom, the tabs configured for securing floor joists thereto.

8. A building according to claim 1, wherein the trailer has a plurality of elongate ties extending upwardly therefrom, the ties being configured for securing the walls to the trailer.

9. A mobile building constructed on a trailer, comprising:
a wheeled trailer upon which the building is built;
a floor and a plurality of walls secured to the trailer; and
a roof structure,
wherein the trailer has a plurality of upwardly extending tabs extending therefrom, the tabs configured for securing floor joists thereto.

10. A building according to claim 9, wherein the tabs are welded to the trailer.

11. A mobile building constructed on a trailer, comprising:
a wheeled trailer upon which the building is built;
a floor and a plurality of walls secured to the trailer; and
a roof structure,
wherein the trailer has a plurality of elongate tie members extending upwardly therefrom, the ties being configured for securing the walls to the trailer.

12. A building according to claim 11, wherein the ties are in the form of elongate, generally planar strips secured to the trailer.

13. A method of constructing a mobile building, including the steps of:
providing a wheeled trailer upon which the building is to be built;
securing a floor, a plurality of walls and a roof structure to the trailer; and
bracing external sides of the walls with sheeting secured to the walls and extending from a base of the building to the roof structure.

14. A method according to claim 13, further including the step of mitre cutting a lowermost purlin of the roof structure to present a flat face generally parallel with the external sides of the walls, and securing the sheeting to the lowermost roof purlin on the flat face.

15. A method according to claim 13, further including the step of securing floor joists to a plurality of upwardly extending tabs extending from the trailer.

16. A method according to claim 13, further including the step of securing the walls to a plurality of elongate ties extending upwardly from the trailer.
